(19) United States
(12) Patent Application Publication
(10) Pub. No.: US 2023/0010445 A1
(43) Pub. Date: Jan. 12, 2023

(54) METHODS AND SYSTEMS FOR GENERATING ACCESS INSTRUCTIONS BASED ON VEHICLE SEAT OCCUPANCY STATUS

(71) Applicant: TOYOTA RESEARCH INSTITUTE, INC., Los Altos, CA (US)

(72) Inventors: Alexander Alspach, Somerville, MA (US); Calder Phillips-Grafflin, Jamaica Plain, MA (US)

(73) Assignee: TOYOTA RESEARCH INSTITUTE, INC., Los Altos, CA (US)

(21) Appl. No.: 17/368,230

(22) Filed: Jul. 6, 2021

(51) Int. Cl. B60W 40/08; G01C 21/34; G06K 9/00

(52) U.S. Cl. CPC B60W 40/08; G01C 21/3438; G06K 9/00838; B60W 2540/045; B60W 2040/0881

(57) ABSTRACT

A method and system for transmitting an access instruction for accessing a vehicle is provided. The system includes a sensory operable to be installed in association with a seat of the vehicle, and a processor that is configured to receive, from a device that is external to the vehicle, a request for accessing the vehicle, determine, using the sensor, an occupation status of the seat of the vehicle, and transmit an access instruction to the device, wherein the access instruction is based on the occupation status of the seat.

### TECHNICAL FIELD

The present specification relates to systems and methods for providing vehicle access instructions to users, and more specifically, to systems and methods for providing access instructions to users based on the occupancy status of vehicle seats.

### BACKGROUND

Conventional travel assistance applications and systems include basic user notification features. For example, users may utilize these applications and systems to request transportation services, e.g., ridesharing, taxi services, etc., and receive text messages informing these users that vehicles have arrived within a certain vicinity of the pick-up locations of these users. However, these users may not know which seats are available for sitting, which door of the vehicle should be opened, how crowded the vehicle is, and so forth.

Accordingly, a need exists for informing users of designated seating areas within vehicles so that the travel experience is efficient and comfortable.

### SUMMARY

In one embodiment, a travel assistance system that is configured to transmit an access instruction based on an occupation status of a seat of a vehicle is provided. The travel assistance system includes a sensor operable to be installed in association with a seat of the vehicle and a processor. The processor is configured to receive, from a device that is external to the vehicle, a request for accessing the vehicle, determine, using the sensor, an occupation status of the seat of the vehicle, and transmit an access instruction to the device, wherein the access instruction is based on the occupation status of the seat.

In another embodiment, a method for transmitting an access instruction based on an occupation status of a seat of a vehicle is provided. The method includes receiving, from a device that is external to a vehicle, a request for accessing the vehicle, determining, using a sensor of the vehicle, an occupation status of a seat of the vehicle, and transmitting an access instruction to the device, wherein the access instruction is based on the occupation status of the seat.

In yet another embodiment, a non-transitory computer-readable medium storing instructions that, when executed by one or more processors of a computing device, cause the computing device to transmit an access instruction based on an occupation status of a seat of a vehicle. Specifically, the non-transitory computer-readable medium storing instructions, when executed by the one or more processors of the computing devices, cause the computing device to detect, using the sensor, a weight value associated with the seat of the vehicle, compare the weight value to a threshold value, and determine that the seat is occupied responsive to the weight value exceeding the threshold value.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example operation of a travel assistance system of the present disclosure, according to one or more embodiments described and illustrated herein;

FIG. 2 schematically depicts non-limiting components of the devices of the present disclosure, according to one or more embodiments described and illustrated herein;

FIG. 3 depicts a flow chart for transmitting access instructions for accessing a vehicle, according to one or more embodiments described and illustrated herein;

FIG. 4A schematically depicts a user interacting with a software application to request travel services, according to one or more embodiments described and illustrated herein;

FIG. 4B schematically depicts an access instruction that is outputted on the display of a mobile device, according to one or more embodiments described and illustrated herein;

FIG. 5A schematically depicts an example operation of the travel assistance system of the present disclosure when a vehicle arrives at a location of a user to transport the user to a destination, according to one or more embodiments described and illustrated herein; and

FIG. 5B schematically depicts another example operation of a travel assistance system of the present disclosure when a vehicle arrives at a location of the user to transport the user to a destination, according to one or more embodiments described herein.

### DETAILED DESCRIPTION

The embodiments of the present disclosure are directed to travel assistance systems that generate access instructions and output these instructions in various forms on displays of user devices. These access instructions are tailored to provide a comfortable, efficient, and user friendly travel experience. To this end, the embodiments described herein enable a user to, via a user device such as a mobile device, a laptop, and so forth, transmit a request to travel via a vehicle and receive, from the vehicle, one or more access instructions. In embodiments, the access instructions may include one or more text messages and/or graphical representations that inform the user of the vehicle occupancy status of one or more seats within the vehicle. The occupancy status of each seat of the vehicle may be determined using data gathered from one or more sensors, e.g., compression sensors, proximity sensors, IR sensors, cameras, and so forth.

In embodiments, the access instructions may be a text message informing the user that the vehicle has arrived and a graphical depiction of a vehicle occupancy map with a seat designated for the user in a particular color, e.g., green, which informs the user at a glance that the user may sit in this seat. In other embodiments, a digital page of a software application (e.g., accessible via a device of a user) may display a notification in the form of a digital banner that appears towards the top of the digital page. Additionally, when the vehicle arrives at the user's location to transport the user, the vehicle may illuminate one or more components in the interior portion and/or exterior portion of the vehicle to draw the user's attention to a designated seat. For example, the travel assistance system may illuminate the door handle adjacent to the user's designated seat as green, which immediately informs the user of the seat in which he should sit. In other embodiments, light components (e.g., LEDs) may be installed on or adjacent to the windows, seats, and so forth, and have the effect of drawing the attention of the user. In this way, upon a vehicle's arrival, a user may efficiently enter the vehicle without wondering which door to open, how crowded the vehicle may be, and so forth.

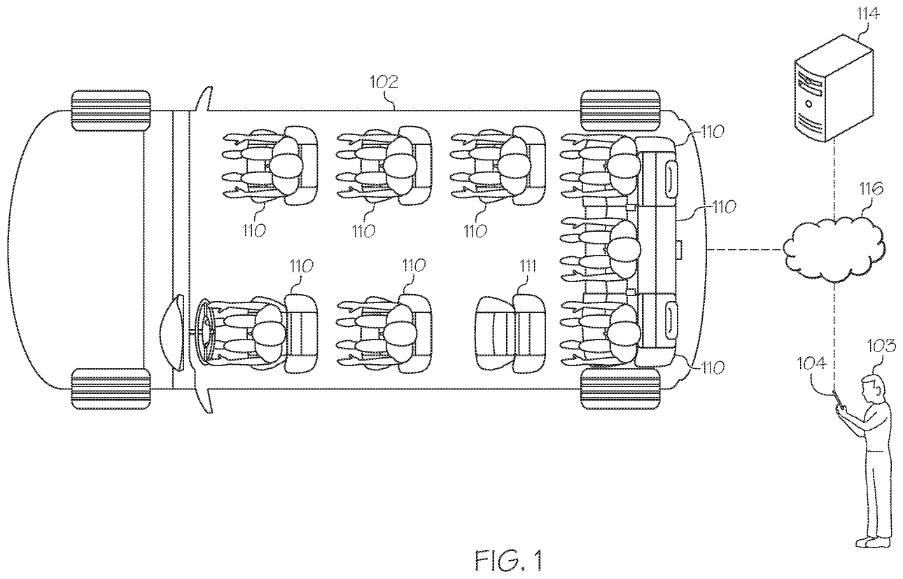

FIG. 1 schematically depicts an example operation of a travel assistance system of the present disclosure, according to one or more embodiments described and illustrated herein. In embodiments, a user 103 may interact with a software application (e.g., a rideshare application) accessible from a mobile device 104 and initiate a request to travel from a particular location to a destination. The request may be communicated from the mobile device 104 to a vehicle 102 via the communication network 116. In embodiments, the request may be output on a display of the vehicle 102 such that an operator of the vehicle 102 may be able to view the request, e.g., in real time. In embodiments, the request may be routed from the mobile device 104 to the server 114 via the communication network 116 prior to being communicated to the vehicle 102.

In embodiments, after receipt of the request, the vehicle 102 may determine occupation status data associated with each of the seats of the vehicle 102, and communicate an access instruction to, via the communication network 116, the mobile device 104. The occupancy status may be determined using one or more sensors, e.g., compression sensors, proximity sensors, IR sensors, cameras, and so forth. These sensors may be placed on, underneath, or adjacent to each seat within the vehicle 102. In embodiments, the access instruction may include a text message indicating a seat that is designated for the user 103, the total number of seats that are occupied and unoccupied (e.g., example occupied seats 110 and example unoccupied seat 111), and so forth. Additionally, a graphical representation of the interior of the vehicle 102 (e.g., a vehicle seat occupancy chart) may also be included. In embodiments, the graphical representation may include a graphical depiction of each seat, with each graphical depiction being illustrated a particular color (e.g., green, red, and so forth). In this way, upon a quick view of the vehicle seat occupancy chart, the user 103 may be able to determine how crowded the vehicle 102 is and where the user 103 should sit inside the vehicle 102. Various other messages may also be communicated simultaneously with the vehicle seat occupancy chart or may be include within a short time period after the vehicle seat occupancy chart is communicated.

Additionally, upon the vehicle 102 arriving at the location of the user 103, portions on the interior and exterior of the vehicle 102 may be illuminated, automatically and without user intervention. For example, the door handles adjacent to certain seats may be illuminated red to indicate that the seats adjacent to these handles are occupied, while other door handles may be illuminated green to indicate that the seats adjacent to these other door handles are unoccupied. In embodiments, the windows or other components in the interior portions and/or the exterior portions of the vehicle 102 may also be illuminated. In this way, the user 103 may be informed of the seat that is reserved or designated for him, thereby making the traveling process more comfortable and user friendly.

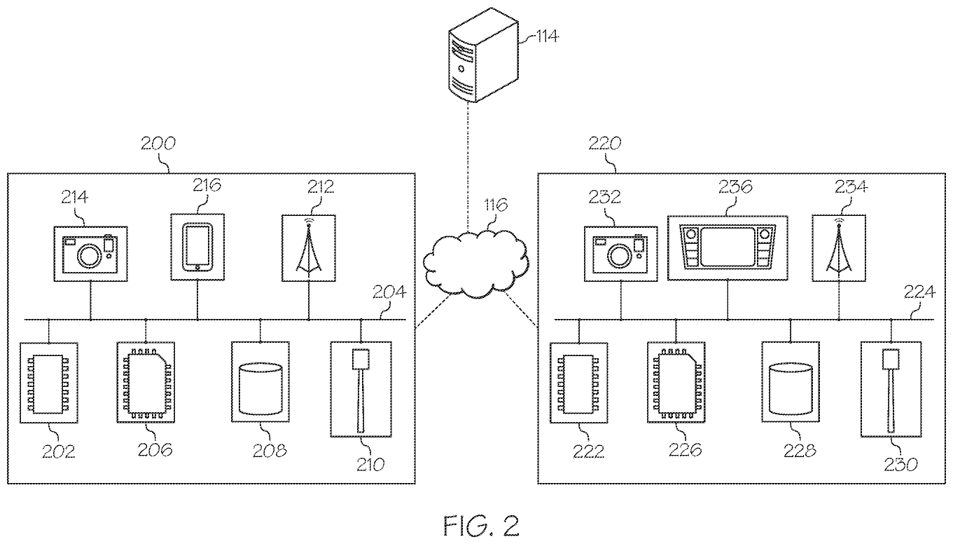

FIG. 2 schematically depicts non-limiting components of the devices of the present disclosure, according to one or more embodiments described and illustrated herein.

FIG. 2 schematically depicts non-limiting components of a mobile device system 200 and a vehicle system 220, according to one or more embodiments shown herein. Notably, while the mobile device system 200 is depicted in isolation in FIG. 2, the mobile device system 200 may be included within a vehicle. A vehicle into which the vehicle system 220 may be installed may be an automobile or any other passenger or non-passenger vehicle such as, for example, a terrestrial, aquatic, and/or airborne vehicle. In some embodiments, these vehicles may be autonomous vehicles that navigate their environments with limited human input or without human input.

The mobile device system 200 and the vehicle system 220 may include processors 202, 222. The processors 202, 222 may be any device capable of executing machine readable and executable instructions. Accordingly, the processors 202, 222 may be a controller, an integrated circuit, a microchip, a computer, or any other computing device.

The processors 202, 222 may be coupled to communication paths 204, 224, respectively, that provide signal interconnectivity between various modules of the mobile device system 200 and vehicle system 220. Accordingly, the communication paths 204, 224 may communicatively couple any number of processors (e.g., comparable to the processors 202, 222) with one another, and allow the modules coupled to the communication paths 204, 224 to operate in a distributed computing environment. Specifically, each of the modules may operate as a node that may send and/or receive data. As used herein, the term “communicatively coupled” means that the coupled components are capable of exchanging data signals with one another such as, for example, electrical signals via conductive medium, electromagnetic signals via air, optical signals via optical waveguides, and the like.

Accordingly, the communication paths 204, 224 may be formed from any medium that is capable of transmitting a signal such as, for example, conductive wires, conductive traces, optical waveguides, or the like. In some embodiments, the communication paths 204, 224 may facilitate the transmission of wireless signals, such as WiFi, Bluetooth®, Near Field Communication (NFC) and the like. Moreover, the communication paths 204, 224 may be formed from a combination of mediums capable of transmitting signals. In one embodiment, the communication paths 204, 224 comprises a combination of conductive traces, conductive wires, connectors, and buses that cooperate to permit the transmission of electrical data signals to components such as processors, memories, sensors, input devices, output devices, and communication devices. Accordingly, the communication paths 204, 224 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The mobile device system 200 and the vehicle system 220 include one or more memory modules 206, 226 respectively, which are coupled to the communication paths 204, 224. The one or more memory modules 206, 226 may comprise RAM, ROM, flash memories, hard drives, or any device capable of storing machine readable and executable instructions such that the machine readable and executable instructions can be accessed by the processors 202, 222. The machine readable and executable instructions may comprise logic or algorithm(s) written in any programming language of any generation (e.g., 1GL, 2GL, 3GL, 4GL, or 5GL) such as, for example, machine language that may be directly executed by the processors 202, 222 or assembly language, object-oriented programming (OOP), scripting languages, microcode, etc., that may be compiled or assembled into machine readable and executable instructions and stored on the one or more memory modules 206, 226 (e.g., non-transitory computer readable medium storing instructions that are executable). Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In some embodiments, the one or more memory modules 206, 226 may store data related to status and operating condition information related to one or more vehicle components, e.g., brakes, airbags, cruise control, electric power steering, battery condition, and so forth.

The mobile device system 200 and the vehicle system 220 may include one or more sensors 208, 228. Each of the one or more sensors 208, 228 is coupled to the communication paths 204, 224 and communicatively coupled to the processors 202, 222. The one or more sensors 228 may include one or more motion sensors for detecting and measuring motion and changes in motion of the vehicle. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle. The one or more sensors may also include a microphone, a motion sensor, a proximity sensor, and so forth. The one or more sensors 228 may also be IR sensors, cameras, proximity sensors, and compression sensors that are configured to determine whether a particular seat with a vehicle is occupied, e.g., whether someone is sitting on a particular seat. In embodiments, the one or more sensors 208 may include a camera or a proximity sensor that detects the presence of one or more objects within a certain proximity of the mobile device into which the mobile device system 200 may be installed.

Still referring to FIG. 2, the mobile device system 200 and the vehicle system 220 optionally includes satellite antennas 210, 230 coupled to the communication paths 204, 224 such that the communication paths 204, 224 communicatively couple the satellite antennas 210, 230 to other modules of the mobile device system 200. The satellite antennas 210, 230 are configured to receive signals from global positioning system satellites. Specifically, in one embodiment, the satellite antennas 210, 230 include one or more conductive elements that interact with electromagnetic signals transmitted by global positioning system satellites. The received signal is transformed into a data signal indicative of the location (e.g., latitude and longitude) of the satellite antennas 210, 230 or an object positioned near the satellite antennas 210, 230, by the processors 202, 222.

The mobile device system 200 and the vehicle system 220 may include network interface hardware 212, 234 for communicatively coupling the mobile device system 200 and the vehicle system 220 with the server 114, e.g., via communication network 112. The network interface hardware 212, 234 is coupled to the communication paths 204, 224 such that the communication path 204 communicatively couples the network interface hardware 212, 234 to other modules of the mobile device system 200 and the vehicle system 220. The network interface hardware 212, 234 may be any device capable of transmitting and/or receiving data via a wireless network, e.g., the communication network 112. Accordingly, the network interface hardware 212, 234 may include a communication transceiver for sending and/or receiving data according to any wireless communication standard. For example, the network interface hardware 212, 234 may include a chipset (e.g., antenna, processors, machine readable instructions, etc.) to communicate over wireless computer networks such as, for example, wireless fidelity (Wi-Fi), WiMax, Bluetooth®, IrDA, Wireless USB, Z-Wave, ZigBee, or the like. In some embodiments, the network interface hardware 212, 234 includes a Bluetooth® transceiver that enables the mobile device system 200 and the vehicle system 220 to exchange information with the server 114 via Bluetooth®.

The network interface hardware 212, 234 may utilize various communication protocols to establish a connection between multiple mobile device and/or vehicles. For example, in embodiments, the network interface hardware 212, 234 may utilize a communication protocol that enables communication between a vehicle and various other devices, e.g., vehicle-to-everything (V2X). Additionally, in other embodiments, the network interface hardware 212, 234 may utilize a communication protocol that is dedicated for short range communications (DSRC). Compatibility with other comparable communication protocols are also contemplated.

It is noted that communication protocols include multiple layers as defined by the Open Systems Interconnection Model (OSI model), which defines a telecommunication protocol as having multiple layers, e.g., Application layer, Presentation layer, Session layer, Transport layer, Network layer, Data link layer, and Physical layer. To function correctly, each communication protocol includes a top layer protocol and one or more bottom layer protocols. Examples of top layer protocols (e.g., application layer protocols) include HTTP, HTTP2 (SPDY), and HTTP3 (QUIC), which are appropriate for transmitting and exchanging data in general formats. Application layer protocols such as RTP and RTCP may be appropriate for various real time communications such as, e.g., telephony and messaging. Additionally, SSH and SFTP may be appropriate for secure maintenance, MQTT and AMQP may be appropriate for status notification and wakeup trigger, and MPEG-DASH/HLS may be appropriate for live video streaming with user-end systems. Examples of transport layer protocols that are selected by the various application layer protocols listed above include, e.g., TCP, QUIC/SPDY, SCTP, DCCP, UDP, and RUDP.

The mobile device system 200 and the vehicle system 220 include cameras 214, 232. The cameras 214, 232 may have any resolution. In some embodiments, one or more optical components, such as a mirror, fish-eye lens, or any other type of lens may be optically coupled to the cameras 214, 232. In embodiments, the camera may have a broad angle feature that enables capturing digital content within a 150 degree to 180 degree arc range. Alternatively, the cameras 214, 232 may have a narrow angle feature that enables capturing digital content within a narrow arc range, e.g., 60 degree to 90 degree arc range. In embodiments, the one or more cameras may be capable of capturing high definition images in a 720 pixel resolution, a 1080 pixel resolution, and so forth. The cameras 214, 232 may capture images of a face or a body of a user and the captured images may be processed to generate identification data associated with the user.

In embodiments, the mobile device system 200 and the vehicle system 220 may include displays 216, 236 for providing visual output. The displays 216, 236 may output digital data, images and/or a live video stream of various types of data. The displays 216, 236 are coupled to the communication paths 204, 224. Accordingly, the communication paths 204, 224 communicatively couple the displays 216, 236 to other modules of the mobile device system 200 and the vehicle system 220, including, without limitation, the processors 202, 222 and/or the one or more memory modules 206, 226.

Still referring to FIG. 2, the server 114 may be a cloud server with one or more processors, memory modules, network interface hardware, and a communication path that communicatively couples each of these components. It is noted that the server 114 may be a single server or a combination of servers communicatively coupled together.

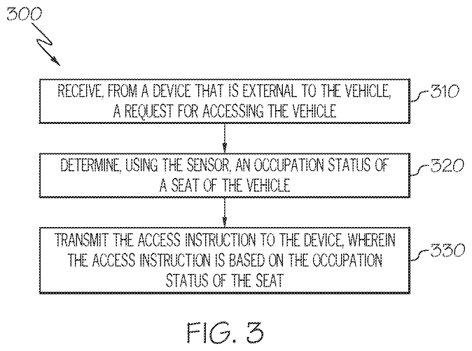

FIG. 3 schematically depicts a flow chart 300 for transmitting access instructions for accessing a vehicle, according to one or more embodiments described and illustrated herein.

In block 310, the processor 222 of the vehicle system 220 that may be installed in the vehicle 102 may receive a request for accessing the vehicle 102 from a device that is external to the vehicle. For example, the processor 222 may receive a request from the mobile device 104, via the communication network 116. The request may be input into text fields of a software application, e.g., a ridesharing program, that is accessed by the user 103 on the mobile device 104. In embodiments, the user 103 may input a destination location into one or more text fields associated with the software application and request a vehicle to transport the user 103 from a source location to the destination location. In other embodiments, the user 103 may utilize other devices to transmit the request, e.g., laptops, desktops, and so forth. In embodiments, the request may be routed from the mobile device 104 to the vehicle 102 via the server 114.

In other embodiments, a mobile device (e.g., a smartphone) associated with a driver of the vehicle 102 may receive the request from a device that is external to the vehicle, namely a mobile device (e.g., a smartphone) of a passenger.

In block 320, upon receiving the request to access the vehicle 102 from the user 103, the processor 222 may determine, using one or more sensors, an occupation status of a seat the vehicle. For example, the processor 222 may receive the request, extract information relating to the destination location of the user 103, and analyze data from one or more sensors positioned at various locations in the interior of the vehicle 102. In embodiments, the sensors may be compression sensors that positioned in association with each seat of the vehicle 102. These compression sensors may be configured to detect whether a passenger is seated in a particular seat, e.g., by comparing a pressure detected by the compression sensor with a threshold weight value and determining that the pressure exceeds the threshold weight value. Other techniques for determining whether a particular seat is occupied are also contemplated. Additionally, cameras, proximity sensors, and IR sensors may also be located in association with each seat within the vehicle 102. The processor 222 may receive data from the sensors associated with each seat of the vehicle 102 and utilize this data to determine a real time vehicle seat occupancy map. In this way, based on data gathered and analyzed, the processor 222 may determine how many passengers are seated within the vehicle at a given time.

Additionally, in some embodiments, the compression sensors, cameras, IR sensors, proximity sensors, etc., may be communicatively coupled to one or more Light Emitting Diodes (LEDs) positioned at various locations within the vehicle 102, e.g., near the windows, on the arm rests, on the door handles, and so forth. In embodiments, upon detecting the presence of a passenger seated on a particular seat, data from the one or more compression sensors (or a combination of other sensors) may, automatically and without user intervention, illuminate an LED positioned near the window. Other operational variations are also contemplated.

In other embodiments, upon receiving the request from a mobile device of a passenger, the driver of the vehicle 102 may, using a mobile device associated the driver, activate an operation of one or more compression sensors positioned at various locations in the interior of the vehicle 102. For example, the user's mobile device may wireless communicate with compression sensors positioned on or underneath each seat, instructing these sensors to detect and analyze compression changes caused by passengers sitting on the seats, e.g., by comparing a pressure or weight value with a threshold weight value. In other embodiments, the compression sensors may be automatically activated upon detecting changes in pressure or weight values (e.g., from a default weight value), and communicate the weight change data directly to the mobile device of the driver. Additionally, IR sensors, cameras, and proximity sensors may also communicate directly with the mobile device of the driver without having to communicate with one or more components of the vehicle 102. In this way, based on data gathered and analyzed, a mobile device of a driver may determine the total number of passengers seated within the vehicle at a given time.

After determining the occupation status of each seat in the vehicle 102, in some embodiments the vehicle 102 may generate an access instruction for transmitting to the mobile device 104 of the user 103. For example, the access instruction to be transmitted may be a text message stating that the second seat behind the driver's seat is unoccupied and available for the user 103. Additionally, the access instruction may also include a graphical representation of the vehicle seat occupancy map of the interior of the vehicle 102, which may provide the user 103 with an accurate and real time indication of the seat occupancy statuses within the vehicle 102. In embodiments, the travel assistance systems described herein may also instruct the driver of the vehicle 102 to travel along a route such that a door of the vehicle 102 (adjacent to the designated seat of the user 103) aligns with a location of the user 103 that is located external to the vehicle 102. In other words, in embodiments, the driver may be instructed to drive along a route that ensures that the user 103 is not required to walk around the vehicle 102 and open a door that is facing a street, e.g., possibly a street on which there may be significant traffic activity.

In other embodiments, the mobile device of the driver may generate an access instruction for transmitting to the mobile device 104 of the user 103. As described above, the access instruction may be a text message that is transmitted to the mobile device 104 of the user 103 from a mobile device of the driver via the communication network 116. In embodiments, the transmission of the text message may be performed automatically and without user intervention by the mobile device of the driver. Additionally, as previously stated, the generated access instruction may include a graphical representation of the vehicle seat occupancy statuses in the interior of the vehicle 102. In embodiments, the generated access instruction may transmitted to the server 114 and then routed to the device 104 via the communication network 116.

In block 330, the processor 222 may transmit the generated access instruction to the mobile device 104 of the user 103. As stated, the access instruction relates to the occupancy status of one or more seats of the vehicle 102. In embodiments, the access instruction may also include a vehicle seat occupancy map and one or more messages (e.g., text messages, mobile application notifications, and the like).

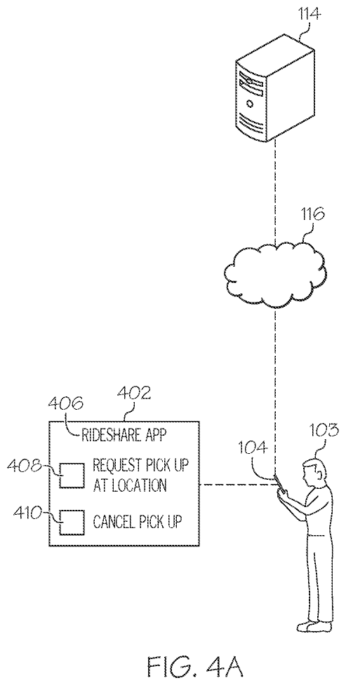

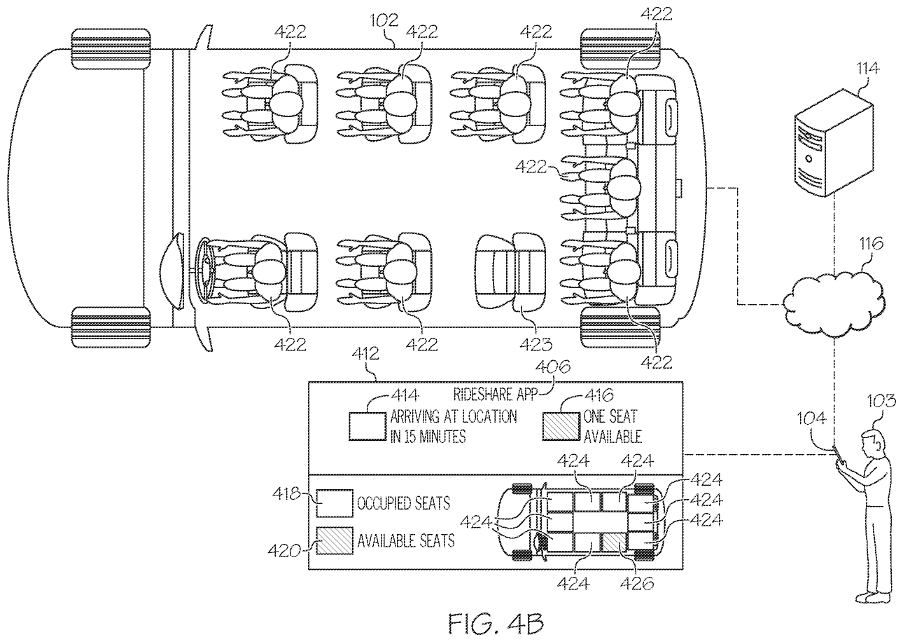

FIG. 4A schematically depicts a user 103 interacting with a software application to request travel services. Specifically, in embodiments, the user 103 may interact with a software application, e.g., a ride share application 406, and transmit a request to be picked up from a current location of the user 103 and dropped off at a destination location. As illustrated, a software application home page 402 may be output onto the display 216 of the mobile device 104 upon the user interacting with an icon on the display 216. In embodiments, the software application home page 402 may include selectable icons such a pick up request icon 408 and a cancel pick up icon 410. The user may select the pick-up request icon 408, which may route a request via the server 114 to the processor 222 of the vehicle 102, e.g., via the communication network 116. Upon receipt of the request, the processor 222 may output a message on the display 216 of the vehicle 102, which may be viewed by a driver. The message may be associated with a software application that is accessible by the processor 222 and various additional external device, e.g., the mobile devices associated with the driver with which the vehicle system 220 may be able to communicate various types of data, e.g., via the communication network 116.

Additionally, as described above, the processor 222 may determine the occupation status of each seat of the vehicle 102, e.g., using a combination of one or more sensors such as the compression sensors, proximity sensors, IR sensors, cameras, and so forth. Additionally, the processor 222 may generate a vehicle seat occupancy map representative of the number of passengers within the vehicle 102 at any given time and where these passengers are seated at this time. The processor 222 may also generate an access instruction in the form of a message indicating which of these seats may be best suitable for the user 103 to sit in. In embodiments, message, e.g., a text message, may be transmitted without the vehicle seat occupancy map. In other embodiments, the message may be included alongside or adjacent to the vehicle seat occupancy map. The message or the message alongside the vehicle seat occupancy map may be transmitted, automatically and without user intervention, by the vehicle system 220 to the mobile device 104.

In embodiments, the access instruction may be generated based on the type of passengers that are transported in the vehicle 102 alongside the user 103. Specifically, if the software application associated with the ride sharing application indicates that a couple of passengers are travelling together (e.g., a pair of passengers such as husband and wife, friends, etc.) and are scheduled to be picked up after the user 103 is scheduled to be picked up, the access instruction may be a text message or a vehicle occupancy seat map indicating that the user 103 should seat in the passenger seat next to the driver (e.g., front seat), even if a couple of seats are in the back of the vehicle 102 are available. In other words, the access instruction may be generated to factor in the fact that the passengers that are traveling together need to be seated together.

In other embodiments, the access instruction may also be generated to simplify the process of the user 103 entering the vehicle 102 at pick up. For example, upon receiving the pick-up request from the mobile device 104, the processor 222 may determine that the user 103 is located on the sidewalk adjacent to a particular store, and instruct the user to sit on a seat that does not require the user 103 to walk towards another part of the vehicle 102, e.g., a part of the vehicle that is adjacent to traffic. Other such embodiments are also contemplated.

FIG. 4B schematically depicts an access instruction that is outputted on the display 216 of the mobile device 104, according to one or more embodiments described and illustrated herein. In embodiments, an access instruction generated by the processor 222 may be received by the mobile device 104, and outputted, automatically and without user intervention, on the display 216 of the mobile device 104. As illustrated in FIG. 4B, a vehicle seat occupancy map may be output onto a vehicle seat occupancy map page 412 on the display 216. The vehicle seat occupancy map page 412 indicates occupied seat graphical icons 424 and unoccupied seat graphical icon 426. In embodiments, the occupied seat graphical icons 424 may be shown in a particular color or pattern that varies from the unoccupied seat graphical icon 426. The occupied seat graphical icons 424 may correspond to the occupation status of the occupied seats 422 and the unoccupied seat 423 (e.g., a different seat) within the vehicle 102, e.g., prior to a time associated with the pick-up time of the user 103. The vehicle seat occupancy map page 412 may also depict a seat availability icon 416 that is shaded in a particular manner or illustrated in a particular color (e.g., green) to indicate to a user 103 the number of seats available for him. The vehicle seat occupancy map page 412 may also indicate overall occupancy status of the vehicle 102 using occupied seats icon 418 and available seats icon 420. For example, as illustrated, the occupied seats icon 418 may be depicted in red (or with a particular shaded pattern) and the available seat icon may be depicted in green (or a particular shaded pattern that is different from the one illustrating the occupied seats icon 418).

Additionally, the vehicle seat occupancy map page 412 may also include an arrival status icon 414, adjacent to which a text message may be shown. The text message may indicate that the vehicle 102 is fifteen minutes away from the location of the user 103. In other embodiments, the vehicle seat occupancy map page 412 may indicate multiple seats available seats, but designate a particular seat for the user 103. For example, as previously stated, if a ridesharing software application 406 associated with the driver of the vehicle 102 indicates that a passenger traveling with his or her relative or friend is scheduled travel in the vehicle 102 after the user 103, then two unoccupied seats that are adjacent to each other may be designated or reserved for the passenger traveling with his or her relative or friend and another seat (e.g., an unoccupied seat with all adjacent seats being occupied) may be designated or reserved for the user 103. In this way, the vehicle system 220 may accommodate the user 103 and the two passengers that enter the vehicle 102 after user 103 within the vehicle 102, in addition to ensuring the two passengers are able to sit next to each other.

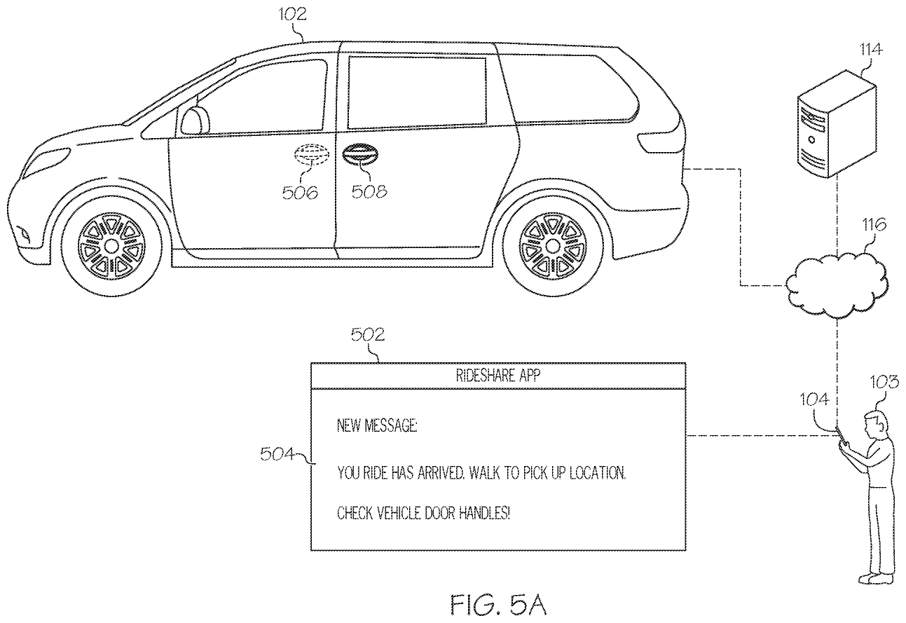

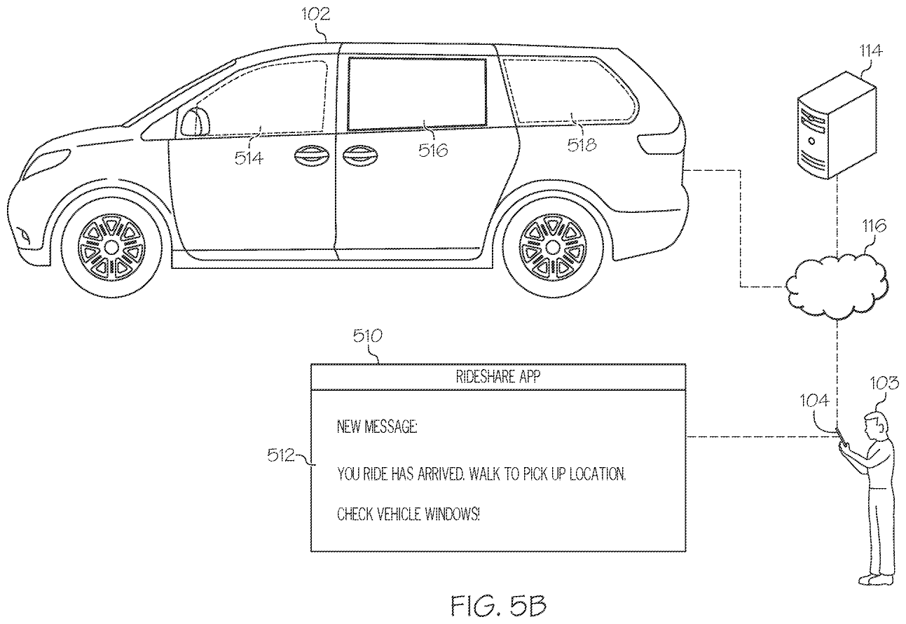

FIG. 5A schematically depicts an example operation of the travel assistance system of the present disclosure when the vehicle 102 arrives at a location of the user 103 to transport the user 103 to a destination, according to one or more embodiments described and illustrated herein. In embodiments, as illustrated in FIG. 5A, when the vehicle 102 arrives at the location of the user 103, the vehicle 102 may communicate a message to the user 103 with one or more instructions that enable the user 103 to enter the vehicle 102 with efficiency and ease. For example, upon arrival, the processor 222 of the vehicle 102 may communicate an arrival text message 504 that may appear as a prompt on an arrival confirmation page 502 of a software application (e.g., the ridesharing application 406) informing the user 103 that the vehicle 102 has arrived at the location of the user 103.

Additionally, in embodiments, the processor 222 may illuminate the handle 508 on the outside of the vehicle a particular color (e.g., green), thereby informing the user 103 that the seat directly adjacent to the door associated with the handle 508 is unoccupied and designated for the user 103. Another door handle, e.g., the driver-side door handle 506 may be illuminated a different color (e.g., red), which informs the user that the seat adjacent to the door associated with this handle is occupied. In embodiments, the door handles associated with the doors adjacent to each occupied seat may be illuminated a certain color (e.g., red), while the door handles associated with each unoccupied seat may be illuminated a different color (e.g., green). In embodiments, one or more LEDs may be installed at various locations on or underneath the door handles and connected, via the communication path 224, to the processor 222. As such, the processor 222 may, automatically and without user intervention, control operation of these LEDs. A variety of other types of light components comparable to LEDs may also be used instead of or in combination with the LEDs. The LEDs and light components may be illuminated to have flashing patterns, solid patterns, and so forth. Such a feature enables the user 103 to easily determine which door of the vehicle 102 should opened, thereby facilitating a comfortable and user friendly travel experience. Additionally, the possibility of awkward interactions between the user 103 and other passengers located within the vehicle 102 is also avoided. Additionally, in embodiments, the processor 222 may generate identification data associated with a passenger accesses the vehicle 102. For example, using cameras, IR sensors, and so forth, the processor 222 may determine a name, contact information, and destination location information associated with the user 103, in addition to performing an authentication operation. In this way, the travel assistance system may verify that the correct individual has been picked up by the driver of the vehicle 102.

FIG. 5B schematically depicts another example operation of the travel assistance system of the present disclosure when the vehicle 102 arrives at a location of the user 103 to transport the user 103 to a destination, according to one or more embodiments described herein. Specifically, upon the vehicle 102 arriving at the location of the user 103, the processor 222 may illuminate one or more components (e.g., LEDs) installed on various interior portions adjacent to the windows of the vehicle 102. For example, one or more LEDs installed adjacent to the windows 514, 516, and 518 may be illuminated automatically. In embodiments, LEDs adjacent to the window 516 may be illuminated green, informing the user 103 that the seat directly adjacent to the door associated with the handle 508 is unoccupied and designated for the user 103. Additionally, LEDs adjacent to the windows 514, 518 may be illuminated red, informing the user 103 that the seats adjacent to the windows 514, 518 are occupied. In embodiments, the LEDs may be illuminated to include a flashing pattern. Other illumination patterns are also contemplated. A variety of other types of light components comparable to LEDs may also be used instead of or in combination with the LEDs

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A travel assistance system comprising:
a sensor operable to be installed in association with a seat of a vehicle;
a processor, wherein the processor is configured to:
receive, from a device that is external to the vehicle, a request for accessing the vehicle;
determine, using the sensor, an occupation status of the seat of the vehicle; and
transmit an access instruction to the device, wherein the access instruction is based on the occupation status of the seat.

2. The travel assistance system of claim 1, wherein the processor determines the occupation status of the seat by:
detecting, using the sensor, a weight value associated with the seat of the vehicle;
comparing the weight value to a threshold value; and
determining that the seat is occupied responsive to the weight value exceeding the threshold value.

3. The travel assistance system of claim 2, wherein the processor transmitting the access instruction to the device includes:
illuminating at least one of an interior portion and an exterior portion of the vehicle that is associated with an unoccupied seat in the vehicle, responsive to the determining that the weight value exceeds the threshold value; and
transmitting a message indicative of the unoccupied seat to the device.

4. The travel assistance system of claim 1, wherein the processor is configured to determine the occupation status of the seat by:
detecting, using the sensor, a weight value associated with the seat of the vehicle;
comparing the weight value to a threshold value; and
determining that the seat is unoccupied responsive to the weight value being less than the threshold value.

5. The travel assistance system of claim 4, wherein the processor transmitting the access instruction to the device includes:
illuminating at least one of an interior portion and an exterior portion of the vehicle that is associated with the seat that is unoccupied, responsive to the determining that the weight value of the seat is less than the threshold value; and
transmitting a message to the device indicating that the seat is unoccupied.

6. The travel assistance system of claim 1, wherein the processor is further configured to generate identification data associated with a user that accesses the vehicle.

7. The travel assistance system of claim 1, wherein the processor is further configured to instruct an operator of the vehicle to drive the vehicle along a route such that a door adjacent to an unoccupied seat of the vehicle aligns with a location of a user that is located external to the vehicle.

8. The travel assistance system of claim 1, wherein the processor is configured to transmit the access instruction to the device by:
determining whether a pair of passengers have requested access to the vehicle subsequent to a user; and
communicating a message to the user instructing the user to sit in a front seat of the vehicle responsive to the determining that the pair of passengers have requested the access to the vehicle subsequent to the user.

9. A method comprising:
receiving, from a device that is external to a vehicle, a request for accessing the vehicle;
determining, using a sensor of the vehicle, an occupation status of a seat of the vehicle; and
transmitting an access instruction to the device, wherein the access instruction is based on the occupation status of the seat.

10. The method of claim 9, wherein the determining of the occupation status of the seat includes:
detecting, using the sensor, a weight value associated with the seat of the vehicle;
comparing the weight value to a threshold value; and
determining that the seat is occupied responsive to the weight value exceeding the threshold value.

11. The method of claim 10, wherein the transmitting of the access instruction to the device includes:
illuminating at least one of an interior portion and an exterior portion of the vehicle that is associated with an unoccupied seat in the vehicle, responsive to the determining that the weight value exceeds the threshold value; and
transmitting a message indicative of the unoccupied seat to the device.

12. The method of claim 9, wherein the determining of the occupation status of the seat of the vehicle includes:
detecting, using the sensor, a weight value associated with the seat of the vehicle;
comparing the weight value to a threshold value; and
determining that the seat is unoccupied responsive to the weight value being less than the threshold value.

13. The method of claim 12, wherein the transmitting of the access instruction to the device includes:
illuminating at least one of an interior portion and an exterior portion of the vehicle that is associated with the seat that is unoccupied, responsive to the determining that the weight value of the seat is less than the threshold value; and
transmitting a message to the device indicating that the seat is unoccupied.

14. The method of claim 9, further comprising generating identification data associated with a user that accesses the vehicle.

15. The method of claim 9, further comprising instructing an operator of the vehicle to drive the vehicle along a route such that a door adjacent to an unoccupied seat of the vehicle aligns with a location of a user that is located external to the vehicle.

16. The method of claim 9, wherein determining the occupation status of the seat of the vehicle includes:
determining whether a pair of passengers have requested access to the vehicle after a user; and
transmit a message to the user instructing the user to sit in a front seat of the vehicle responsive to the determining that the pair of passengers have requested the access to the vehicle.

17. A non-transitory computer-readable medium storing instructions that, when executed by one or more processors of a computing device, cause the computing device to:
receive, from a device that is external to a vehicle, a request for accessing the vehicle;
determine, using a sensor, an occupation status of a seat of the vehicle; and
transmit an access instruction to the device, wherein the access instruction is based on the occupation status of the seat.

18. The non-transitory computer-readable medium of claim 17, wherein the non-transitory computer-readable medium storing instructions, when executed by the one or more processors of the computing device, further cause the computing device to:
detect, using the sensor, a weight value associated with the seat of the vehicle;
compare the weight value to a threshold value; and
determine that the seat is occupied responsive to the weight value exceeding the threshold value.

19. The non-transitory computer-readable medium of claim 18, wherein the non-transitory computer-readable medium storing instructions, when executed by the one or more processors of the computing device, causes the computing device to transmit the access instruction to the device by:
illuminating at least one of an interior portion and an exterior portion of the vehicle that is associated with an unoccupied seal in the vehicle, responsive to the determining that the weight value exceeds the threshold value; and
transmitting a message indicative of the unoccupied seat to the device.

20. The non-transitory computer-readable medium of claim 17, wherein the non-transitory computer-readable medium storing instructions, when executed by the one or more processors of the computing device, further cause the computing device to generate identification data associated with a user that accesses the vehicle.
